(19) United States
(12) Patent Application Publication
(10) Pub. No.: US 2021/0134236 A1
(43) Pub. Date: May 6, 2021

(54) CONTROL DEVICE, DISPLAY DEVICE, AND CONTROL METHOD

(71) Applicant: SHARP KABUSHIKI KAISHA, Sakai City, Osaka (JP)

(72) Inventors: MAKOTO SHIOMI, Sakai City, Osaka (JP); NAOKO GOTO, Sakai City, Osaka (JP); NAOTO INOUE, Sakai City, Osaka (JP); AYA OKAMOTO, Sakai City, Osaka (JP); OSAMU TERANUMA, Sakai City, Osaka (JP); MASAO KURINO, Sakai City, Osaka (JP); YUKI KATSUMURA, Sakai City, Osaka (JP)

(21) Appl. No.: 17/251,136

(22) PCT Filed: May 30, 2019
(86) PCT No.: PCT/JP2019/021588

§ 371 Date: Dec. 10, 2020

(30) Foreign Application Priority Data
Jun. 15, 2018 (JP) 2018-114853

(51) Int. Cl. G09G 3/34; G09G 3/36

(52) U.S. Cl. CPC G09G 3/3426; G09G 2320/0686; G09G 2320/062; G09G 3/36

(57) ABSTRACT

To provide a control device capable of reducing power consumption of a display device. A display controller is a control device of a display device including a display including a plurality of light sources to be independently controlled. The control device performs first display processing that involves causing a light source, corresponding to a display region for notice information, to glow more brightly than another light source if the notice information is displayed on a part of the display when the display device is in a lock state. The notice information presents a user a notice, and the light source and the other light source are included in the light sources.

### TECHNICAL FIELD

A disclosure below relates to a control device to control how to display an image, a display device including the control device, and a control method for controlling how to display an image.

### BACKGROUND ART

Techniques to reduce power consumption of image display devices performing high-dynamic-range (HDR) rendering are disclosed in such related art documents as Patent Document 1. The invention disclosed in Patent Document 1 limits regions to be subjected to the HDR rendering to a specific region to reduce power consumption. The specific region is, for example, an image region on which a user desires the HDR rendering to he performed.

### CITATION LIST

### Patent Literature

[Patent Document 1] Japanese Unexamined Patent Application Publication No. 2017-045030 (published on Mar. 2, 2017)

### SUMMARY OF INVENTION

### Technical Problem

Unfortunately, Patent Document 1 fails to disclose a technique to reduce power consumption without deteriorating visibility in obtaining information.

An aspect of the present disclosure is intended to provide, for example, a control device capable of reducing power consumption, without compromising visibility in obtaining information displayed on a display device.

### Solution to Problem

In order to solve the above problem, a control device according to an aspect of the present disclosure is of a display device including a display including a plurality of light sources to be independently controlled. The control device performs first display processing that involves causing a light source, corresponding to a display region for notice information, to glow more brightly than another light source if the notice information is displayed on a part of the display when the display device is in a lock state, the notice information presenting a user a notice, and the light source and the other light source being included in the light sources.

Moreover, a control device according to an aspect of the present disclosure is of a display device including a display including a plurality of light sources to be independently controlled. The control device performs second display processing that involves causing a light source, corresponding to a display region for notice information, to glow less brightly than another light source if the notice information is displayed on a part of the display when the display device is in an unlock state, the light source and the other light source being included in the light sources.

Furthermore, a control method according to an aspect of the present disclosure is for controlling a display device including a display including a plurality of light sources to be independently controlled, The control method includes first display processing that involves causing a light source, corresponding to a display region for notice information, to glow more brightly than another light source if the notice information is displayed on a part of the display when the display device is in a lock state, the notice information presenting a user a notice, and the light source and the other light source being included in the light sources.

Moreover, a control method according to an aspect of the present disclosure is for controlling a display device including a display including a plurality of light sources to be independently controlled. The control method includes second display processing that involves causing a light source, corresponding to a display region for notice information, to glow less brightly than another light source if the notice information is displayed on a part of the display when the display device is in an unlock state, the light source and the other light source being included in the light sources.

### ADVANTAGEOUS EFFECTS OF INVENTION

A control device according to an aspect of the present disclosure can reduce power consumption, without compromising visibility in obtaining information displayed on a display device.

### BRIEF DESCRIPTION OF DRAWINGS

FIG. 1 is a block diagram illustrating a configuration of a display device according to a first embodiment.

FIG. 2 includes illustrations (a) to (c) each showing an example of how to display notice information.

FIG. 3 includes an illustration (a) for showing an example of image processing using a local dimming function, and a graph (b) showing a grayscale value, of liquid crystal data in the illustration (a), taken along line A-A.

FIG. 4 is a flowchart showing an operation of the display device according to the first embodiment.

FIG. 5 is a flowchart showing an operation of a display device according to a second embodiment.

FIG. 6 is a block diagram illustrating a configuration of a display device according to a third embodiment.

FIG. 7 is a block diagram illustrating specific configurations of a backlight-data generator, and a liquid-crystal-data generator according to the third embodiment.

FIG. 8 is a flowchart showing an operation of the display device according to the third embodiment.

FIG. 9 is a graph showing backlight brightness with respect to input image brightness, liquid crystal transmittance, and output brightness of the display device according to the third embodiment.

FIG. 10 is a block diagram illustrating a configuration of a display device according to a fourth embodiment.

FIG. 11 is a block diagram illustrating configurations of a backlight-data generator, a liquid-crystal-data generator, and a brightness reduction processor according to the fourth embodiment.

FIG. 12 is a graph showing backlight brightness with respect to input image brightness, liquid crystal transmittance and output brightness of the display device according to the fourth embodiment.

FIG. 13 is a graph showing an example of a relationship between brightness of a pixel before processing and brightness of the pixel after processing performed by the brightness reduction processor included in the display device according to the fourth embodiment.

FIG. 14 is a block diagram illustrating other configurations, than those in FIG. 11, of the backlight-data generator, the liquid-crystal-data generator, and the brightness reduction processor according to the fourth embodiment.

FIG. 15 is a flowchart showing processing performed by the display device according to the fourth embodiment.

### DESCRIPTION OF EMBODIMENTS

### First Embodiment

A first embodiment of the present disclosure will be described below in detail.

### Configuration of Display Device 1

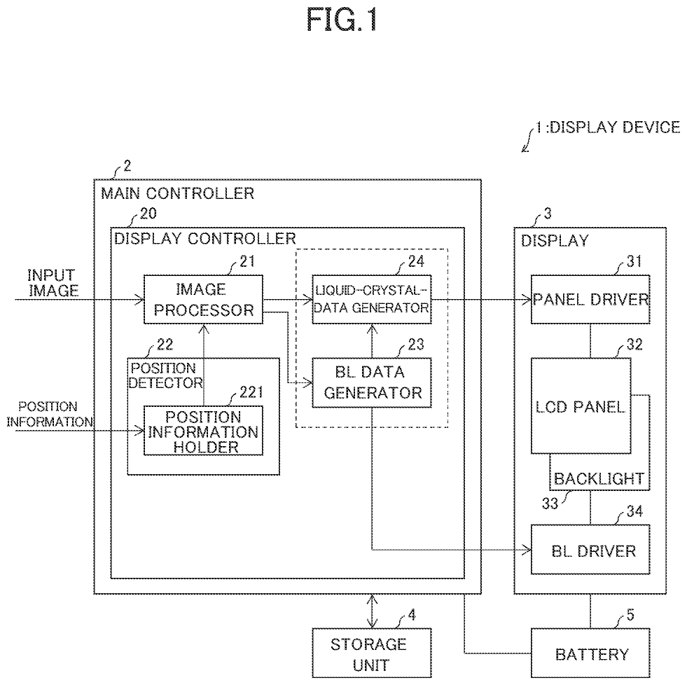

FIG. 1 is a block diagram illustrating a configuration of a display device 1 according to the first embodiment. As illustrated in FIG. 1, the display device 1 displays various kinds of input images. The display device 1 includes: a main controller 2; a display 3; a storage unit 4; and a battery 5. The display device 1 is, for example, a personal digital assistance.

The main controller 2 has overall control of the display device 1. The storage unit 4 stores such data as a program to be processed by the main controller 2. The battery 5 stores power to be supplied to units of the display device 1. That is, the units of the display device 1 are driven by the battery 5.

The display 3 displays an input image processed by a display controller (a control device) 20. In the first embodiment, the display 3 is a liquid crystal display (LCD). Specifically, the display 3 includes: a panel driver 31; an LCD panel 32; a backlight 33; and a backlight driver 34. Note that, in the drawings, the term “backlight” is also denoted as “BL.”

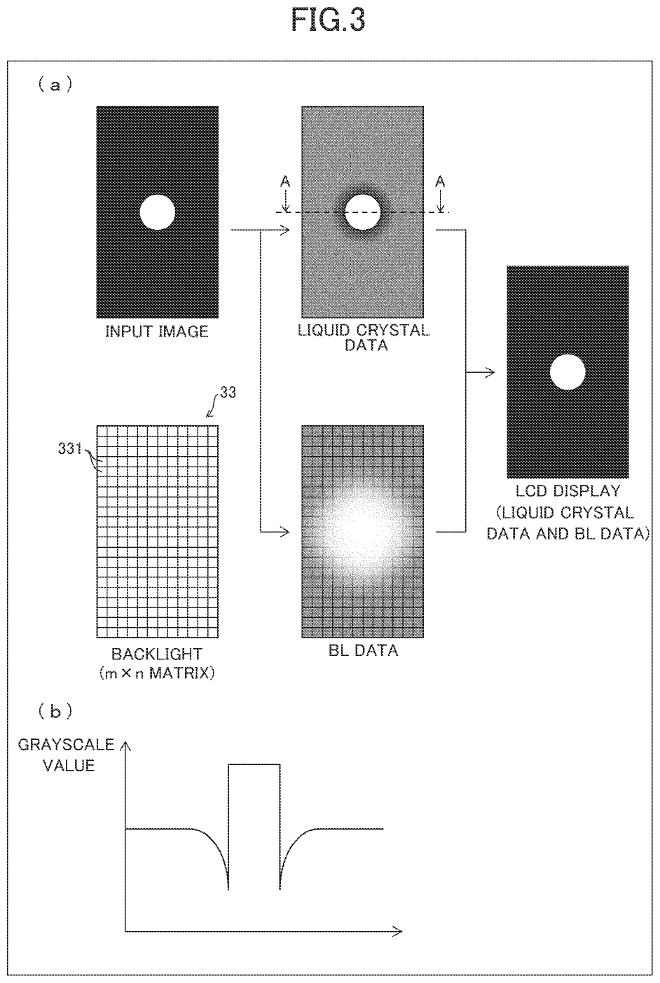

The panel driver 31 controls to drive the LCD panel 32 in accordance with liquid crystal data based on the input image processed by the display controller 20. The LCD panel 32 displays the processed input image. The backlight 33 includes a plurality of light sources 331 (see FIG. 3) to be independently controlled. The backlight driver 34 causes the backlight 33 to glow in accordance with backlight data based on the input image processed by the display controller 20.

The main controller 2 includes the display controller 20 to control the display 3. If notice information Inf is displayed on a part of the display 3 when the display device 1 is in a lock state, the display controller 20 causes a light source 331, corresponding to a notice information display region Ar1 (a display region) for the notice information Inf, to glow more brightly than another light source 331 (first display processing). Here, the light source 331 and the other light source 331 are included in the light sources 331 of the backlight 33.

In the first embodiment, the notice information Inf is assumed to be important for a user using the display device 1. On the basis of this assumption, the first embodiment involves decreasing brightness of a region other than the display region for the notice information Inf to reduce power consumption.

### Example of Notice Information

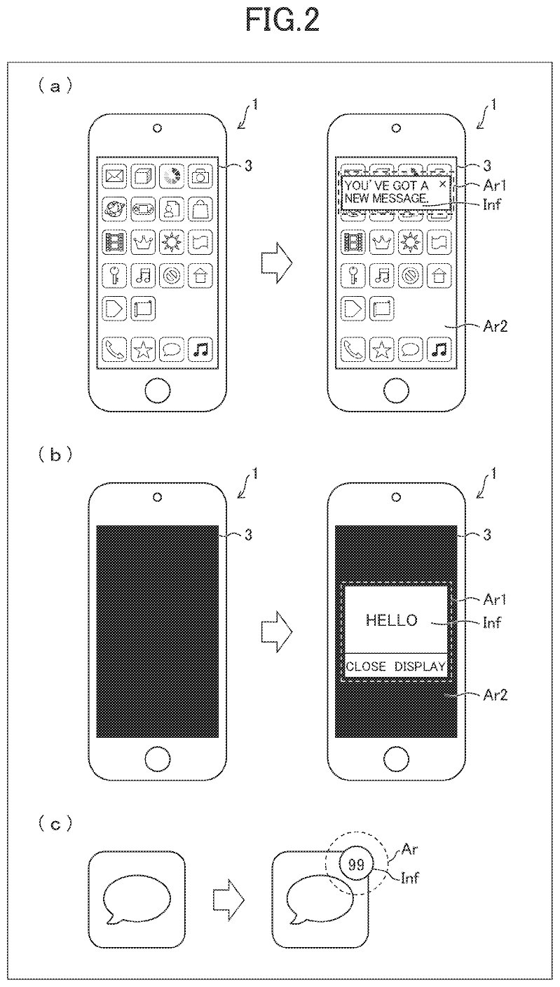

The notice information Inf is information to present the user a notice. An example of the notice information Inf includes information to be generated by various kinds of applications. FIG. 2 includes illustrations (a) to (c) each showing an example of how to display the notice information Inf. As shown in the illustrations (a) and (b) of FIG. 2, the notice information Inf may be information to be displayed in push notification (e.g., information to notify the user of reception of such information as an e-mail message issued by an application). As shown in the illustration (b) in FIG. 2, the notification information Inf may include an e-mail message. Moreover, as shown in the illustration (c) in FIG. 2, the notice information may be information to be displayed when a notification badge is presented (e.g., information indicating the number of incoming information messages issued by applications).

As shown in the illustrations (a) to (c) in FIG. 2, the notice information Inf is displayed in the notice information display region Ar1; that is, a part of the display region on the display 3 (i.e., the display region on the LCD 32). Note that the region other than the notice information display region Ar1 is referred to as an information undisplay region Ar2.

### Local Dimming Function

In the first embodiment, processing to display the notice information Inf is performed, using a local dimming function. In the local dimming function, the display region of the LCD 32 is divided into a matrix, and each of the light sources 331 of the backlight 33 is controlled to glow for a corresponding one of the divided sub-regions (namely, local areas, or blocks). Described here with reference to illustrations (a) and (b) in FIG. 3 is an example of image processing performed on the local dimming function. The illustration (a) in FIG. 3 shows an example of the image processing. The illustration (b) in FIG. 3 is a graph showing a grayscale value, in the illustration (a) of FIG. 3, taken along line A-A. In the illustration (b) of FIG. 3, the horizontal axis and the vertical axis respectively represent a position and a grayscale value on the line A-A.

In an input image in the illustration (a) of FIG. 3, a region with a higher grayscale value is colored more whitishly. Furthermore, the display region of the LCD panel 32 (i.e., the backlight 33 corresponding to the display region) is divided into the sub-regions (an m×n matrix). The illustration (a) of FIG. 3 shows that the backlight 33 is divided into m×n sub-regions. Each of the sub-regions includes one of the light sources 331. Note that each sub-region may include two or more of the light sources 331.

When the local dimming function is used to process an image as shown in the illustration (a) of FIG. 3, backlight data to control brightness of the backlight 33 is generated in accordance with a brightness value (or a pixel value) of the input image. Specifically, the input image is divided into regions each corresponding to one of the sub-regions. In accordance with a brightness value of the divided region, determined as the backlight data is a light-source brightness value of each light source 331 included in a corresponding one of the sub-regions of the backlight 33. In the first embodiment, the backlight data is generated by a backlight-data generator 23.

In accordance with the backlight data and the brightness values of the input image, liquid crystal data to control the LCD panel 32 is generated. Specifically, brightness distribution of the backlight 33 is calculated in accordance with the backlight data and a brightness spread function (i.e., a point spread function, or PSF) which is data representing how light spreads in values. Each of the brightness values (normalized values) of the input image is divided by a corresponding one of brightness values (normalized values) fir brightness distribution of the backlight 33, thus determining an output value (a liquid crystal transmittance) for each pixel of the LCD panel 32. As data to indicate this output value, the liquid crystal data shown in the illustration (b) of FIG. 3 is generated. In the first embodiment, the liquid crystal data is generated by a liquid-crystal-data generator 24.

The liquid crystal data in the illustration (b) of FIG. 3 shows that, of a dark region included in the input image and having low brightness, a region, corresponding to a region away from a center region whose brightness is high, has a small brightness value in backlight brightness distribution. Hence, the grayscale value of the corresponding region is large. Meanwhile, of a region included in the input image and having low brightness, a region, near the center region whose brightness is high, has a large brightness value in backlight brightness distribution because of an effect of the center region whose brightness is high. Hence, the grayscale value of the region is small.

The panel driver 31 drives the LCD panel 32 with the output values indicated in the liquid crystal data, and, simultaneously, the backlight driver 34 causes the backlight 33 to glow with the light-source brightness values indicated in the backlight data. This is how the LCD 32 displays the input image.

In the first embodiment, the backlight-data generator 23 and the liquid-crystal-data generator 24 respectively generate the backlight data and the liquid crystal data using not only the input image but also a processed image to be described later.

### Details of Display Controller 20

As illustrated in FIG. 1, in order to perform the above display processing, the display controller 20 includes: an image processor 21; a position detector 22; the backlight-data generator 23; and the liquid-crystal-data generator 24. The backlight-data generator 23 and the liquid-crystal-data generator 24 have the local dimming function, and act as an LCD controller to directly control the display 3 as an LCD.

If the notice information Inf is displayed on a part of the display 3 when the display device 1 is in the lock state, the image processor 21 increases brightness of a region, for the notice information Inf, in the input image to be higher than that of another region in the input image.

In the first embodiment, the image processor 21 sets all of the screen of the display 3 to a dark region. Specifically, the image processor 21 decreases (e.g., halves) the brightness of all of the input image. Note that, if the input image includes the notice information Inf, the image processor 21 sets the region, for displaying the notice information Inf, to a bright region. In other words, the image processor 21 decreases brightness of a part, of the input image, to be displayed in the dark region. Thanks to such a feature, the image processor 21 can increase the brightness of the region, for the notice information Inf, of the input image to be higher than that of the information undisplay region.

For the sake of simplicity, in the description below, a region, of the input image, corresponding to the dark region of the display 3 is also referred to as a dark region. Likewise, a region, of the input image, corresponding to the bright region of the display 3 is also referred to as a bright region.

The position detector 22 detects a display position of the notice information Inf. In the first embodiment, the position detector 22 detects the above display position by obtaining position information front an application generating the notice information Inf (i.e., an application issuing the input image). Note that the position information may indicate a position of a group of pixels constituting the notice information Inf. In such a case, the position detector 22 identifies the display position from the position of the pixel group.

Moreover, the position detector 22 includes a position information holder 221 temporality holding the obtained position information. The position information holder 221 transmits the position information to the image processor 21 when the image processor 21 receives the input image corresponding to the obtained position information. The position information holder 221 can provide the position information to the image processor 21 when the image processor 21 processes the input image. Note that the position information holder 221 is not necessarily essential if (i) the position information can be provided to the image processor 21 in processing the input image, or (ii) the image processor 21 can hold the position information.

The backlight-data generator 23 generates backlight data in accordance with the image processed by the image processor 21 (i.e., a processed image). That is, the backlight-data generator 23 generates the backlight data so that, when the notice information Inf is displayed on a part of the display 3, the light source 331 corresponding to the display region for the notice information Inf glows more brightly than the other light source 331 (i.e., a light source 331 corresponding to the dark region).

The liquid-crystal-data generator 24 generates liquid-crystal data in accordance with the image processed by the image processor 21 (i.e., a processed image), and the backlight data generated by the backlight-data generator 23.

Hence, because the backlight data generator 23 and the liquid-crystal-data generator 24 respectively generate the backlight data and the liquid crystal data in accordance with the display position detected by the position detector 22, the display controller 20 can perform the above display processing in accordance with the display position.

### Operation of Display Device 1

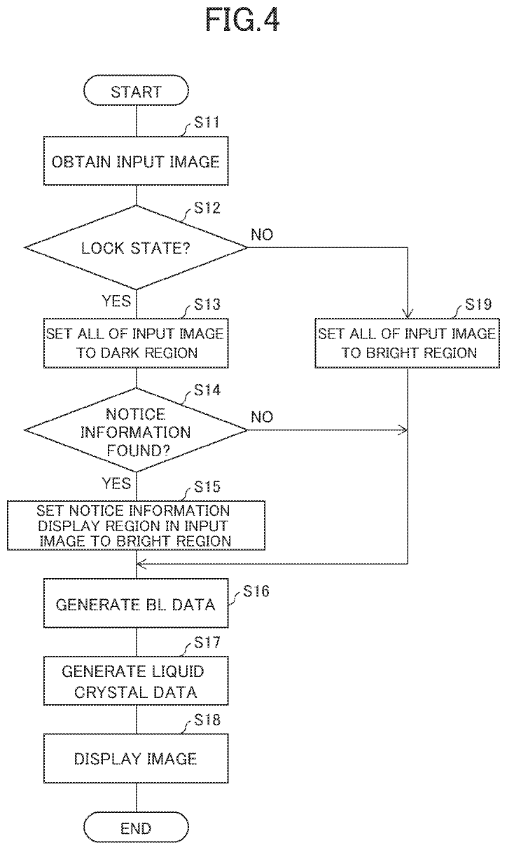

FIG. 4 is a flowchart showing an operation of the display device 1.

In the display device 1, first, the image processor 21 obtains an input image (S11). Next, the image processor 21 determines whether the display device 1 is in the lock state (S12). If the display device 1 is in the lock state (YES at S12), the image processor 21 sets all of the input image to a dark region (S13). Specifically, the image processor 21 decreases the brightness of all of the input image.

If the obtained input image includes the notice information Inf (YES at 514), the image processor 21 generates a processed image in accordance with a display position, of the notice information Inf, detected by the position information detector 22 (515). Here, in the processed image, only the notice information display region is the bright region.

After that, in accordance with the generated processed image, the backlight data generator 23 generates backlight data (S16), and the liquid-crystal-data generator 24 generates liquid crystal data (S17). The display 3 displays an image, using the generated backlight data and liquid crystal data (S18).

Thanks to the above processing flow, the light source 331 corresponding to the display region for the notice information Inf glows in normal brightness, and the other light source 331 corresponding to the information undisplay region glows less brightly than the light source 331 corresponding to the display region for the notice information Inf. Such a feature makes it possible to reduce power consumption of the display device 1, without deteriorating visibility of the notice information Inf.

If the display device 1 is not in the lock state (NO) at S12), the image processor 21 does not change the brightness of the input image, and sets all of the input image to a bright region (S19). After that, the processing in the above steps S16 to S18 is executed. Moreover, if the display device 1 is in the lock state and no notice information Inf is found (NO at S14), the step S15 is skipped and the processing in steps S16 to S18 is executed.

### Second Embodiment

A second embodiment of the present disclosure will be described below. A configuration of a display device according to the second embodiment, which is the same as that of the display device 1 according to the first embodiment, will be described with reference to FIG. 1.

In the second embodiment, the image processor 21 sets all of the screen of the display 3 to a bright region when the display device is not in the lock state. In this state, if the notice information Inf is displayed on a part of the display 3, the image processor 21 decreases brightness of a region, for the notice information Inf, in the input image to be lower than that of an information undisplay region in the input image. Specifically, if the notice information Inf is displayed on a part of the display 3, the image processor 21 sets a display region for the notice information Inf to a dark region.

The second embodiment is different from the first embodiment, assuming that the notice information Inf is not important for a user of the display device 1. On the basis of this assumption, the second embodiment involves decreasing brightness of the display region for the notice information Inf to reduce power consumption.

The backlight-data generator 23 in the second embodiment generates backlight data in accordance with an image (i.e., a processed image) subjected to the above image processing by the image processor 21. That is, if the notice information Inf is displayed on a part of the display 3 when the display device 1 is not in the lock state (i.e., in an unlock state), the backlight data generator 23 of the second embodiment causes a light source 331, corresponding to the display region for the notice information Inf, to glow less brightly than another light source 331 (second display processing). In other words, the backlight generator 23 decreases the brightness of the light source 331 corresponding to the above dark region to be lower that of the other light source 331 corresponding to the above bright region.

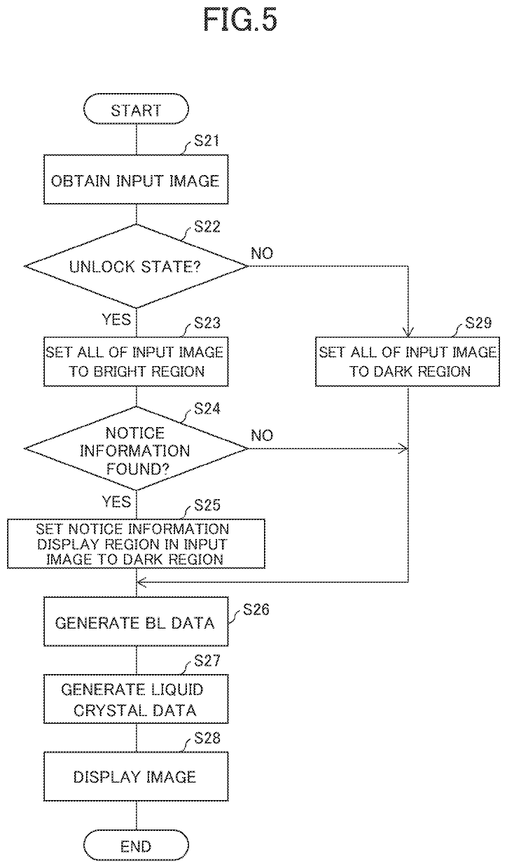

FIG. 5 is a flowchart showing an operation of the display device 1 according to the second embodiment. In the description below, specific processing for setting of the bright region and the dark region is similar to that in the first embodiment. Hence, the description of the processing will be omitted.

In the second embodiment, the image processor 21 obtains an input mage (S21), and then determines whether the display device 1 is in the unlock state (S22). If the display device 1 is in the unlock state (YES at S22), the image processor 21 sets all of the input image to a bright region (S23).

If the obtained input image includes the notice information Inf (YES at S24), the image processor 21 generates a processed image whose notice information display region is a dark region (S25).

After that, in accordance with the generated processed image, the backlight data generator 23 generates backlight data (S26), and the liquid-crystal-data generator 24 generates liquid crystal data (S27). The display 3 displays an image, using the generated backlight data and liquid crystal data (S28).

Thanks to the above processing flow, the light source 331 corresponding to the display region for the notice information Inf glows less brightly than the light source 331 corresponding to the information undisplay region. For the user engaged on the operation of the display device 1, the notice information Inf is of low importance. Hence, the notice information Inf is displayed less brightly, making it possible to reduce power consumption. The information undisplay region is displayed in normal brightness, maintaining the visibility of important information for the user.

If the display device 1 is not in the unlock state (NO at S22), the image processor 21 sets all of the input image to a dark region (S29). After that, the processing in the above steps S16 to S18 is executed. Moreover, if the display device 1 is in the unlock state and no notice information Inf is found (NO at S24), the step S25 is skipped and the processing in steps S26 to S28 is executed.

Note that the display device 1 may combine the processing in the first embodiment and the processing in the second embodiment together, and execute the combined processing. That is, the display device 1 may execute the processing in the first embodiment in the lock state, and the processing in the second embodiment in the unlock state. In such a case, power consumption decreases in both the lock state and the unlock state.

As a matter of course, in the combination of the processing of the first embodiment and the processing of the second embodiment, each processing may provide a dark region with a different brightness decrease level. For example, the processing in the first embodiment may decrease the brightness of the dark region to one fifth of the normal brightness, and the processing in the second embodiment may decrease the brightness of the dark region to half of the normal brightness.

In such a case, the image processor 21 has to hold brightness decrease levels. For example, the position detector 22 may provide the image processor 21 with information indicating a brightness decrease level together with the position information. Alternatively, the image processor 21 may previously hold information indicating a brightness decrease level corresponding to the lock state or the unlock state.

### Third Embodiment

A third embodiment of the present disclosure will be described below.

In the display device 1 of the first and second embodiments, the image processor 21 decreases the brightness of the display region for the notice information Inf in the input image or the brightness of the information undisplay region in the input image. In contrast, a display device 1A of a third embodiment generates backlight data to limit an upper limit of brightness of a light source 331 corresponding to a display region in which brightness decreases, and to keep the light source 331 from glowing more brightly than the upper limit.

The third embodiment describes a specific example in which this technique to reduce power consumption is applied to the display device 1 of the second embodiment. As seen in the second embodiment, the notice information Inf in the third embodiment is assumed not to be important for a user of the display device 1. On the basis of this assumption, the third embodiment involves setting brightness of the notice information display region Ar1 to an upper limit or blow to reduce power consumption.

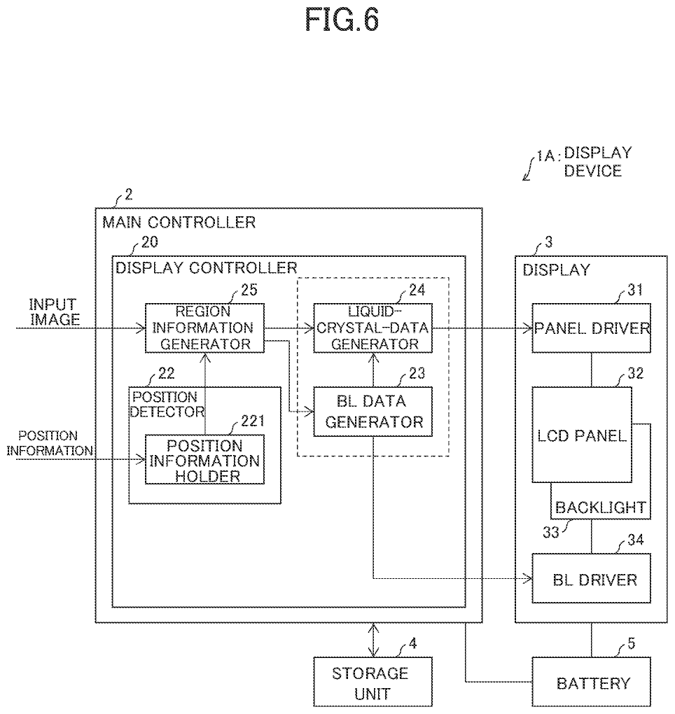

FIG. 6 is a block diagram illustrating a configuration of the display device 1A according to the third embodiment. As illustrated in FIG. 6, the display device 1A includes a region information generator 25 instead of the image processor 21.

The region information generator 25 applies the above the power consumption reduction technique to the display region for the notice information Inf, but not to the information undisplay region. A display region to which the power consumption reduction technique is applied is referred to as a low brightness region, and a region to which the power consumption reduction technique is not applied is referred to as a bright region.

Specifically, the region information generator 25 determines the bright region and the low brightness region in accordance with a position of a notice region detected by the position detector 22, and outputs an input image and data indicating the bright region and the low brightness region to the backlight-data generator 23. If the brightness, of the light source 331 corresponding to the low brightness region, determined in accordance with the input image is higher than the predetermined upper limit, the backlight-data generator 23 of the third embodiment generates backlight data in which the brightness is decreased to the predetermined upper limit.

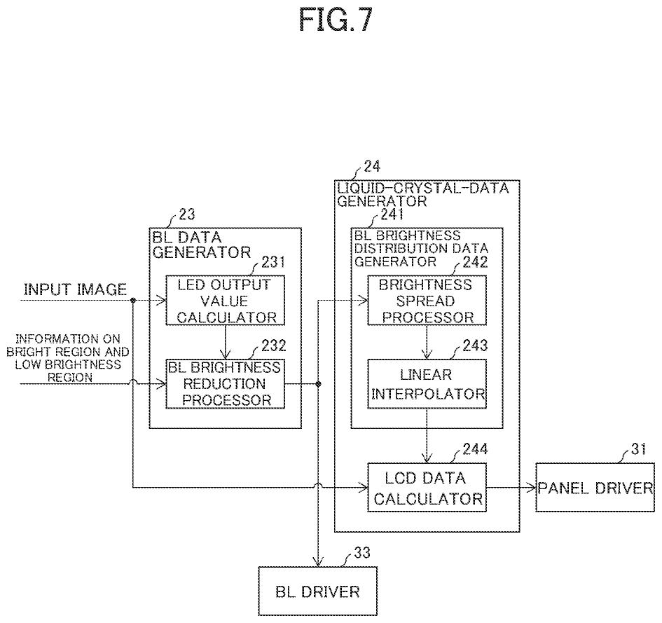

FIG. 7 is a block diagram illustrating specific configurations of the backlight-data generator 23 and the liquid-crystal-data generator 24 according to the third embodiment. As illustrated in FIG. 7, the backlight-data generator 23 includes: an LED output value calculator 231; and a BL brightness reduction processor 232. The liquid-crystal-data generator 24 includes: a BL brightness distribution data generator 241; and an LCD data calculator 244.

The LED output value calculator 231 calculates output values (brightness) of the light sources 331 for the regions of the backlight 33 in accordance with a brightness value of an input image, and outputs the calculated output values to the BL brightness reduction processor 232. If brightness of a light source 331 corresponding to a low brightness region is higher than a predetermined upper limit, the BL brightness reduction processor 232 decreases the brightness to the predetermined upper limit. The data indicating the corrected output value of the light source 331 is output as the backlight data to the backlight driver 34 and the liquid-crystal-data generator 24.

Note that the BL brightness reduction processor 232 may use another technique to correct brightness of a light source 331. For example, the BL brightness reduction processor 232 may set, for brightness of a tight source 331, the predetermined upper limit and a threshold smaller than the upper limit. The BL brightness reduction processor 232 may then correct brightness, of a light source 331, exceeding the threshold by reducing the brightness within a range from the threshold to the upper limit. Moreover, the BL brightness reduction processor 232 may correct brightness of the light source 331 corresponding to a low brightness region by multiplying the brightness value of the light source 331 by a factor larger than or equal to 0 and smaller than or equal to 1. In such a case, the above factor may be (i) a constant value independent from the brightness of the light source 331, and (ii) a value variable, depending on the brightness of the light source 331, in accordance with a predetermined function (or a value incrementally variable).

The BL brightness distribution data generator 241 includes: a brightness spread processor 242; and a linear interpolator 243. The brightness spread processor 242 calculates data of brightness distribution among individual light sources 331 in accordance with an output value of an LED and a predetermined brightness point spread function (PSF). The liner interpolator 243 linearly interpolates the data of brightness distribution among the individual light sources 331 to calculate data of brightness distribution throughout the backlight 33. The LCD data calculator 244 calculates liquid crystal data in accordance with the data of brightness distribution throughout the backlight 33 and with an input image. The LCD data calculator 244 outputs the calculated liquid crystal data to the panel driver 31.

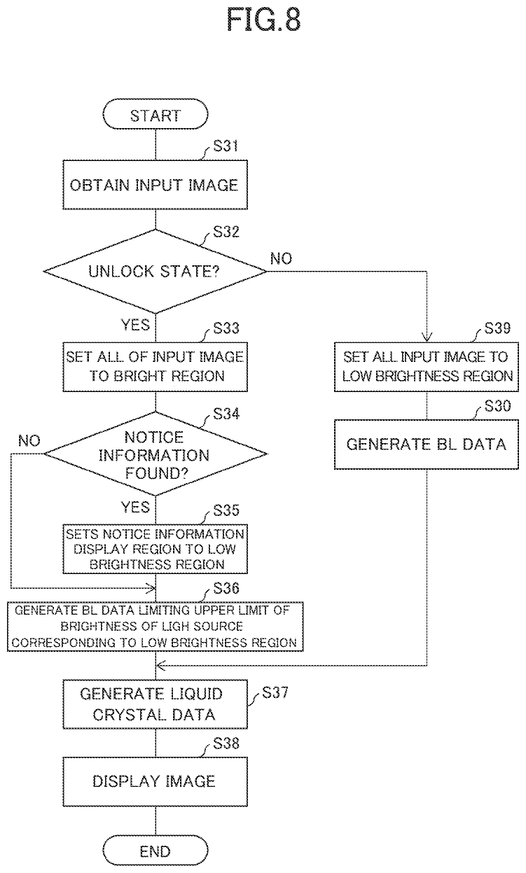

FIG. 8 is a flowchart showing an operation of the display device 1A.

In the display device 1A, first, the region information generator 25 obtains an input image (S31), and determines whether the display device 1A is the unlock state (S32). If the display device 1A is in the unlock state (YES at S32), the region information generator 25 sets all of the input image to a bright region (S33). Setting to a bright region in the third embodiment is different from that in the first embodiment in that the former setting involves generating information to identify the region as a bright region.

If the obtained input image includes the notice information Inf (YES at S34), the region information generator 25 sets a notice information display region in the input image to a low brightness region (S35). Specifically, the region information generator 25 generates information (tow-brightness-region identification information) to identify a position of the notice information display region, in the input image, to be displayed as the low brightness region.

After that, the backlight data generator 23 generates backlight. data in accordance with the input image and the low-brightness-region identification information (S36). Specifically, in the backlight data generator 23, the LED output value calculator 231 calculates output values of the light sources 331, and then the BL brightness reduction processor 232 reduces brightness of a light source 331, corresponding to the low brightness region, to a predetermined upper limit. Moreover, the liquid-crystal-data generator 24 generates liquid crystal data in accordance with the input image and the backlight data (S37). The display 3 displays an image, using the generated backlight data and liquid crystal data (S38).

If the display device 1A is not in the unlock state (NO at S32), the region information generator 25 sets all of the input image to the low brightness region (S39), and generates backlight data (S30). After that, the processing in the above steps S37 and S38 is executed. Moreover, if the display device 1 is in the unlock state and no notice information Inf is found (NO at S34), the step S35 is skipped and the processing in steps S36 to S38 is executed.

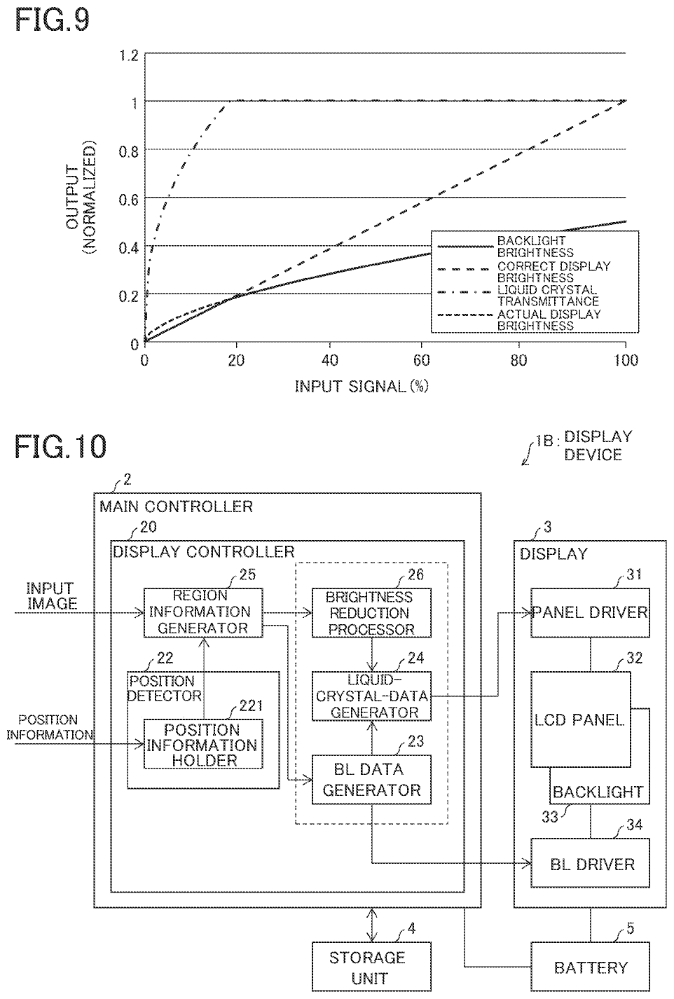

FIG. 9 is a graph showing backlight brightness with respect to input image brightness, liquid crystal transmittance, and output brightness of the display device 1A.

As illustrated in FIG. 9, the brightness of the backlight 33 in the display device 1A is reduced to half of the normal brightness at most. In the display device 1A, when the input image has a brightness of approximately 18%, the brightness of the backlight 33 is equal to that of the input image. Hence, the liquid crystal transmittance is 1. When the brightness of the input image exceeds approximately 18%, the brightness of an output image falls below that of the input image. In such a case, representation of grayscale brightness depends on backlight brightness. That is why the grayscale brightness is represented poorly. The poor grayscale brightness is otherwise a cause of a poor image. In the third embodiment, however, the notice information is basically not important for the user. Hence, information to be presented in the notice information display region does not have to be presented using a complex grayscale pattern. For example, even if the notice information display region is presented in two colors; that is, a text message in white and others in black, problems do not develop more often than not. Hence, in many cases, this limitation of the brightness does not cause a faulty image. Note that the brightness of 18% is an example determined by a test pattern for evaluating the brightness, and is variable depending on an actual usage environment of the display device 1A. Examples of the usage environment include: a pattern of the input image; an area of a low brightness region; a positional relationship between the low brightness region and a high brightness region; an average brightness of the high brightness region; and a backlight brightness, of the high brightness region, related to the average brightness.

As can be seen, in the display device 1 of the first and second embodiments, the image processor 21 decreases brightness, of an input image, corresponding to a notice information display region. As a result, brightness of the backlight 33 corresponding to the notice information display region decreases, reducing power consumption of the display device 1.

In contrast, in the display device 1A, brightness of a light source 331 corresponding to the notice information display region has an upper limit, and the backlight data generator 23 causes the light source 331 not to glow more brightly than the upper limit. This is how the display device 1A reduces its power consumption.

In setting the upper limit of the backlight brightness (the brightness of the light source 331), for example, an amount of power to be consumed by the display device 1A may be determined, and the upper limit may be set to correspond to the determined power consumption.

Furthermore, in setting the upper limit of the backlight brightness, for example, an upper limit may be determined for the brightness of a display image whose grayscale representation is desirably maintained. Accordingly, the upper limit of the backlight brightness may be set to correspond to the upper limit of the brightness of the display image. In such a case, for a pixel, of the pixels included in the dark region, whose brightness in the input image is lower than or equal to the above upper limit, the brightness of the display image can be controlled with the liquid crystal transmittance. Hence, the brightness can be controlled precisely.

Note that, in the display devices according to an aspect of the present disclosure, the image processor 21 of the first embodiment and the backlight data generator 23 of the third embodiment may be used in combination. That is, the image processor 21 may decrease the brightness of the input image, and then, the backlight data generator 23 may decrease the backlight brightness in the backlight data.

Moreover, the technique to reduce power consumption according to the third embodiment may be applied to the display device of the first embodiment. In such a case, the information undisplay region is set as a low brightness region.

### Fourth Embodiment

A fourth embodiment of the present disclosure will be described below.

FIG. 10 is a block diagram illustrating a configuration of a display device 1B according to the fourth embodiment. As illustrated in FIG. 10, in addition to the constituent features of the display device 1A, the display device 1B further includes a brightness reduction processor 26.

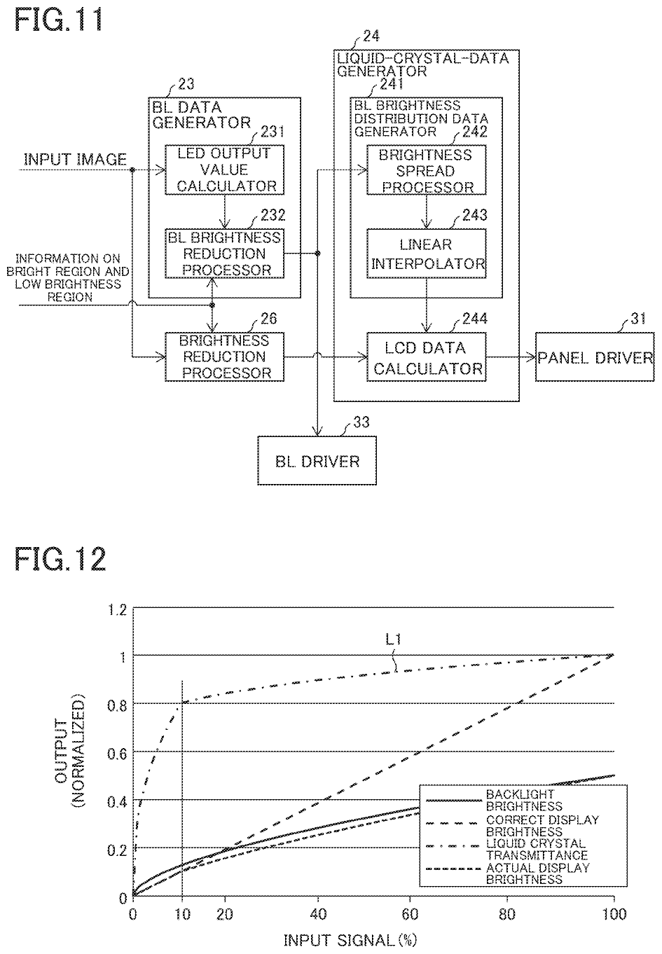

FIG. 11 is a block diagram illustrating configurations of the backlight-data generator 23, the liquid-crystal-data generator 24, and the brightness reducing processor 26 according to the fourth embodiment. The brightness reduction processor 26 receives an input image, backlight data, and information on a bright region and a low brightness region, and then reduces brightness of some of pixels of the input image to generate a processed image.

As illustrated in FIG. 9, in the case where the brightness of the backlight 33 is decreased to 50%, and the liquid crystal data is generated in accordance with the brightness value of an input image, the input signal strength (e.g., the grayscale value) of the input image is 18% of the maximum strength, and the liquid crystal transmittance is 100%. Hence, when the liquid crystal transmittance reaches 100% in the case where the backlight brightness has the upper limit and the input image is displayed as it is, and the liquid crystal transmittance does not increase depending on the brightness of the pixels of the input image, such a situation is referred to as “the liquid crystal transmittance is saturated,” When the liquid crystal transmittance is saturated, the liquid crystal cannot provide fine grayscale representation. As described before, when the display device 1 is used under normal conditions, the saturation of the liquid crystal transmittance does not cause a serious problem to an image. Depending on a usage of the display device 1, however, it can be highly likely that maintaining the information on the grayscale is preferable.

Hence, for a pixel, of an input image, whose liquid crystal transmittance is higher than or equal to a predetermined value (except for a pixel having the maximum brightness), the brightness reduction processor 26 decreases the brightness of the pixel in a predetermined manner to keep the liquid crystal transmittance from reaching 100% not to saturate the liquid crystal transmittance. The above predetermined value may be, for example, 80%. In the example illustrated in FIG. 9, the input signal strength of the input image is approximately 15%, and the liquid crystal transmittance is 80%.

FIG. 12 is a graph showing backlight brightness with respect to input image brightness, liquid crystal transmittance, and output brightness of the display device 1B. For a pixel, in a low brightness region of the input image, with an input signal strength of 15% or greater, the brightness reduction processor 26 decreases the brightness of the pixel and generates a processed image. A curve L1 in FIG. 12 shows a relationship between the input signal strength and the liquid crystal transmittance of the processed image. That is, the brightness reduction processor 26 decreases the brightness of each pixel in the low brightness region of the input image so that the relationship between the input signal strength and the liquid crystal transmittance of the processed image is represented by the curve L1 (i.e., a predetermined relationship).

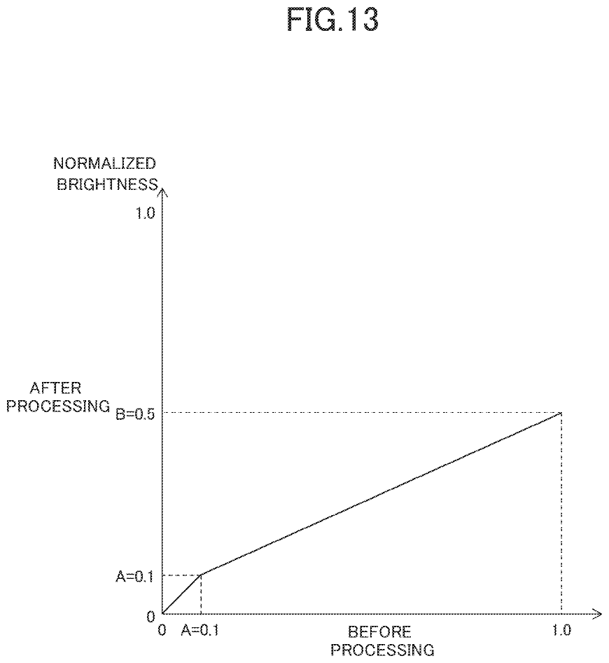

FIG. 13 is a graph showing an example of a relationship between brightness of a pixel before processing and brightness of the pixel after processing performed by the brightness reduction processor 26 included in the display device 1B. For example, the brightness reduction processor 26 decreases brightness of a pixel in a low brightness region of an input image so that the brightness of the pixel before processing and the brightness of the pixel after processing represent the relationship illustrated in the graph of FIG. 13. More specifically, the brightness reduction processor 26 applies: an expression (1) below if the brightness of the pixel before processing is 0 or higher and A or lower; and an expression (2) below if the brightness of the pixel before processing is higher than A and 1 or lower.

$$\begin{matrix}y = x & ( 1 ) \\ [ Math . 1 ] & \\ y = \frac{A - B}{A - 1} x + A \frac{B - 1}{A - 1} & ( 2 )\end{matrix}$$

The processing using the expressions (1) and (2) is an example. Other than this linear processing, the brightness reduction processor 26 can perform processing, using a lookup table based on any given preferable curve. Note, however, that, as described before, it is not so important for the brightness reduction processor 26 to precisely perform processing when the display device 1B is used under normal conditions.

In the case where the pixel values of the input image are represented by R, G, and B, the brightness reduction processor 26 may perform the above processing on each of the values of R, G, and B. Moreover, the brightness reduction processor 26 may selectively perform the above processing on any one of R, G, and B, and reduce brightness of the other colors in accordance with a reduction rate of the selected color. Such processing is preferable if a change in shade of color needs to be minimized in the low brightness region. The one color to be selected may be, for example, a predetermined one of the colors (e.g., G), or one of R, G, and B having the largest grayscale. Moreover, the brightness reduction processor 26 may transform the values of R, G, and B into brightness values and chromaticity values, and perform the above processing on the brightness values.

The liquid-crystal-data generator 24 generates liquid crystal data in accordance with a processed image whose brightness of a low brightness region is lower than that of an input image, making it possible to reduce the risk that the liquid transmittance is saturated.

Hence, the display device 1B in the fourth embodiment allows the liquid crystal to achieve fine grayscale representation even if (i) power consumption is reduced and (ii) the input image is high in brightness.

Note that, in the brightness reduction processor 26, the above predetermined value of the liquid crystal transmittance to determine whether the brightness of the input image is to be decreased shall not be limited to 80%. The predetermined value may be determined as appropriate.

As described before, an object of the display devices according to the present disclosure is to reduce power consumption of the devices by generating a low brightness region, and to maximize visibility even in the low brightness region. Here, the processing performed by the BL brightness reduction processor 232 in FIG. 11 is the only processing directed to reduction in power consumption. The processing performed by the brightness reduction processor 26 contributes only to visibility, not to reduction in power consumption. Meanwhile, as described before, it is not so important to precisely present brightness of grayscale in a low brightness region. That is, the processing by the brightness reduction processor 26 may be directed only to the visibility of the low brightness region.

The brightness reduction processing described with reference to FIG. 13 involves reducing the brightness of the input image on the assumption that the upper limit of the backlight brightness in the low brightness region is 50% (i.e., the brightness of grayscale can be precisely represented if the backlight brightness is 50% or below). If the backlight brightness is lower than 50%, however, an upper limit of an input brightness to be represented by precise grayscale is also naturally low. Such a feature makes it possible to increase visibility without raising a compression ratio of the input brightness.

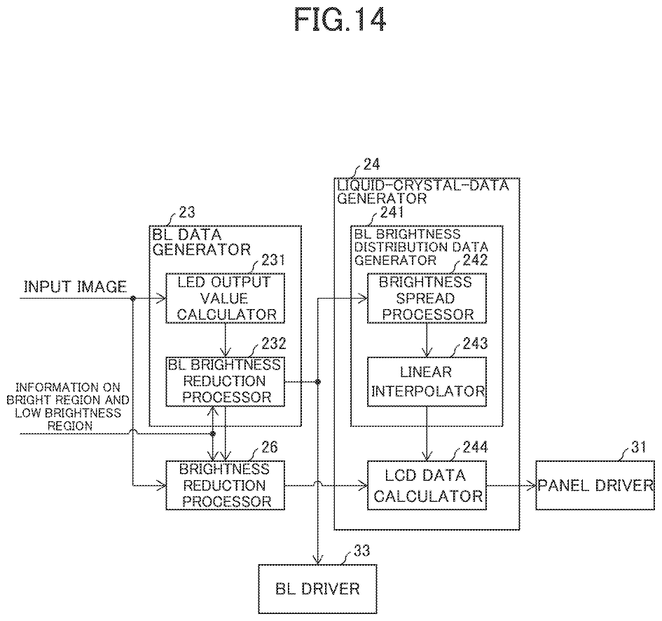

FIG. 14 is a block diagram illustrating other configurations, than those in FIG. 11, of the backlight-data generator 23, the liquid-crystal-data generator 24, and the brightness reduction processor 26 according to the fourth embodiment. In the configurations illustrated in FIG. 14, BL brightness information on a low brightness region is output from the BL brightness reduction processor 232 to the brightness reduction processor 26. Such a feature makes it possible to optimize presentation of messages while power consumption of the display device 1B is maintained low.

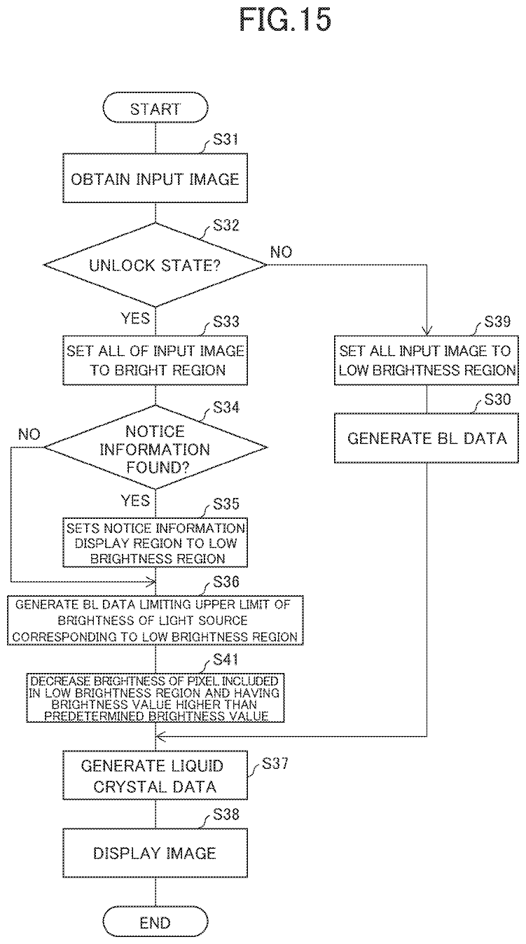

FIG. 15 is a flowchart showing processing performed by the display device 1B according to the fourth embodiment. Comparing the processing by the display device 113 in the fourth embodiment with the processing in the third embodiment, the only difference is that, in the former processing, Step S41 is performed between Steps S36 and S37.

In the display device 1B of the fourth embodiment, backlight data is generated at Step S36. After that, the brightness reduction processor 26 decreases brightness of a pixel included in the pixels of a low brightness region and having a liquid crystal transmittance higher than or equal to a predetermined rate (S41). After that, the liquid-crystal-data generator 24 generates liquid crystal data in accordance with a processed image Whose brightness is decreased by the brightness reduction processor 26 (S37).

### Additional Remarks

In the above embodiments, the battery 5 supplies power to the display device. This is because a battery-powered display device is strongly required to reduce power consumption and extend battery life. The technique of this present disclosure may; however, be applied to a display device powered by an external power supply. As a matter of course, such a display device can reduce power consumption, using the techniques of the present disclosure.

The present disclosure shall not be limited to the embodiments described above, and can be modified in various manners within the scope of claims. The technical aspects disclosed in different embodiments are to be appropriately combined together to implement another embodiment, Such an embodiment shall be included within the technical scope of the present disclosure. Moreover, the technical aspects disclosed in each embodiment may be combined to achieve a new technical feature.

### CROSS REFERENCE TO RELATED APPLICATION

The present application claims priority to Japanese Patent Application No, 2018-114853, filed Jun. 15, 2018, the contents of which are incorporated herein by reference in its entirety.

### Software Implementation

The main controller 2 of the display devices 1, 1A, and 1B may be implemented by logic circuits (hardware) fabricated, for example, in the form of an integrated circuit (an IC chip) and may be implemented by software rim by a central processing unit (a CPU).

In the latter form of implementation, the display devices 1, 1A, and 1B include, among others: a CPU that executes instructions from programs or software by which various functions are implemented; a read-only memory (a ROM) or a like storage device (referred to as a “storage medium”) containing the programs and various data in a computer-readable (or CPU-readable) format; and a random access memory (a RAM) into which the programs are loaded. The computer (or CPU) then retrieves and runs the programs contained in the storage medium, thereby achieving the object of an aspect of the present disclosure. The storage medium may be a “non-transitory; tangible medium” such as a tape, a disc/disk, a card, a semiconductor memory; or programmable logic circuitry. The programs may be supplied to the computer via any transmission medium (e.g., over a communications network or by broadcasting waves) that can transmit the programs. The present disclosure, in an aspect thereof, encompasses data signals on a carrier wave that are generated during electronic transmission of the programs.

### REFERENCE SIGNS LIST

1, 1A, 1B Display Device

3 Display

20 Display Controller (Control Device)

331 Light Source

1-9. (canceled)

10. A control device of a display device including a display including a plurality of light sources to be independently controlled,
the control device performing first display processing that involves causing a light source, corresponding to a display region for notice information, to glow more brightly than another light source if the notice information is displayed on a part of the display when the display device is in a lock state, the notice information presenting a user a notice, and the light source and the other light source being included in the light sources.

11. The control device according to claim 10, wherein
the control device sets all of a screen of the display to a dark region when the display device is in the lock state, and when the notice information is displayed, the control device performs the first display processing by causing the light source, corresponding to the display region for the notice information, to glow more brightly than the other light source corresponding to the dark region.

12. The control device according to claim 10, wherein
the light sources glow less brightly in a display region assigned as a dark region than in another display region, and the control device decreases brightness of a part of an input image to be displayed in the dark region to decrease brightness of a light source corresponding to the dark region, the light source being included in the light sources.

13. The control device according to claim 10, wherein
the light sources glow less brightly in a display region assigned as a dark region than in another display region, and the control device decreases an upper limit of brightness of a light source corresponding to the dark region, the light source being included in the light sources.

14. A display device comprising the control device according to claim 10.

15. A control device of a display device including a display including a plurality of light sources to be independently controlled,
the control device performing second display processing that involves causing a light source, corresponding to a display region for notice information, to glow less brightly than another light source if the notice information is displayed on a part of the display when the display device is in an unlock state, the light source and the other light source being included in the light sources.

16. The control device according to claim 15, wherein
the control device sets all of a screen of the display to a bright region when the display device is in the unlock state,
when the notice information is displayed, the control device sets the display region for the notice information to a dark region, and
the control device performs the second display processing by causing the light source, corresponding to the dark region, to glow less brightly than the other light source corresponding to the bright region.

17. The control device according to claim 15, wherein
the light sources glow less brightly in a display region assigned as a dark region than in another display region, and the control device decreases brightness of a part of an input image to be displayed in the dark region to decrease brightness of a light source corresponding to the dark region, the light source being included in the light sources.

18. The control device according to claim 15, wherein
the light sources glow less brightly in a display region assigned as a dark region than in another display region, and the control device decreases an upper limit of brightness of a light source corresponding to the dark region, the light source being included in the light sources.

19. A display device comprising the control device according to claim 15.

20. A control method for controlling a display device including a display including a plurality of light sources to be independently controlled, the control method comprising
first display processing that involves causing a light source, corresponding to a display region for notice information, to glow more brightly than another light source if the notice information is displayed on a part of the display when the display device is in a lock state, the notice information presenting a user a notice, and the light source and the other light source being included in the light sources.
